(19) United States
(12) Patent Application Publication
(10) Pub. No.: US 2015/0295756 A1
(43) Pub. Date: Oct. 15, 2015

(54) Hybrid Optical/Electrical Interconnect Network Architecture for Direct-connect Data Centers and High Performance Computers

(71) Applicant: NEC Laboratories America, Inc., Princeton, NJ (US)

(72) Inventors: Yawei Yin, Plainsboro, NJ (US); Philip Ji, Cranbury, NJ (US); Konstantinos Kanonakis, New Brunswick, NJ (US); Ting Wang, West Windsor, NJ (US)

(21) Appl. No.: 14/682,382

(22) Filed: Apr. 9, 2015

Related U.S. Application Data
(60) Provisional application No. 61/978,060, filed on Apr. 10, 2014.

(51) Int. Cl. H04L 12/24; H04Q 11/00

(52) U.S. Cl. CPC H04L 41/083; H04L 41/12; H04Q 11/0071; H04L 41/0826; H04Q 2011/009; H04Q 2011/0081

(57) ABSTRACT

The present invention proposes a hybrid optical/electrical network architecture for the direct-connect datacenters and HPC systems. It utilizes small scale optical switches in parallel with the electrical switching modules (e.g. the multi-port NIC) in the direct-connect electrical network (e.g 3D Torus) in order to provide optical bypassing capabilities. The optical network keeps the same topology as the electrical packet switching network, while the number of optical nodes can be equal or less than the electrical switching modules.

### RELATED APPLICATION INFORMATION

This application claims priority to provisional application No. 61/978,060, filed Apr. 10, 2014, entitled “Hybrid Optical/Electrical Interconnect Network Architecture for Direct-Connect Data Centers and High Performance Computers”, the contents thereof are incorporated herein by reference.

### BACKGROUND OF THE INVENTION

The present invention relates generally to optics, and more particularly, to a hybrid/electrical interconnect network architecture for direct connect data centers and high performance computers.

The following references are noted herein in the background discussion of the application:
[1] http://top500.org/lists/2013/11/.
[2] H. Abu-Libdeh, P. Costa, A. Rowstron, G. O'Shea, and A. Donnelly. “Symbiotic Routing in Future Data Centers”. In Proceedings of the ACM SIGCOMM Conference on Data Communication, pages 51-62, New Delhi, India, August 2010.
[3] C. Guo, G. Lu, D. Li, H. Wu, X. Zhang, Y. Shi, C. Tian, Y. Zhang, and S. Lu. “BCube: A High Performance, Server-Centric Network Architecture for Modular Data Centers.” In Proceedings of the ACM SIGCOMM Conference on Data Communication, pages 63-74, Barcelona, Spain, August 2009.
[4] C. Guo, H. Wu, K. Tan, L. Shi, Y. Zhang, and S. Lu. “DCell: A Scalable and Fault-Tolerant Network Structure for Data Centers”. In Proceedings of the ACM SIGCOMM Conference on Data Communication, pages 75-86, Seattle, Wash., USA, August 2008.
[5] N. Farrington et. al., “Helios: A Hybrid Electrical/Optical Switch Architecture for Modular Data Center,” Proc. of SIGCOMM, pp. 339-350, October 2010.
[6] G. Wang et. al., “c-Through: Part-Time Optics in Data Centers,” Proc. of SIGCOMM, pp. 327-338, October 2010.

The direct-connect topology such as Torus has been pervasive in high performance computing (HPC) systems, e.g. the IBM Sequoia-BlueGene/Q computer (FIG. 1 a) uses a 5D Torus architecture and the Fujitsu K-Computer (FIG. 1 b) comprises a 6D Torus network [1]. Recently, the Data Center Networking (DCN) community has also shown the interest in building the networks based on direct-connect architectures. CamCube [2] is such an instance which consists of a 3D Torus topology, while DCell [3] and BCube [4] use partial direct-connect networks in their architecture. In these systems, the traditional hierarchical switching architecture collapses into small and distributed switching systems. More specifically, the costly network switches in the tree-based topology are (partially) replaced by Network Interface Cards (NICs) with limited (but integrated) switching functionalities. By doing this, the switching and routing functionalities are shifted from the dedicated network switches/routers to the datacenter nodes. Such a shift in switching functionalities can dramatically reduce the cabling complexity, improve the scalability of the network, and provide new functionalities such as content addressing that might be a better fit for common data center applications such as key-value stores.

However, the direct-connect topology approaches have their inherent shortcomings. For example, as the high-degree dedicated switches are replaced with low-degree switching modules on the datacenter nodes, the average hops between the datacenter nodes are dramatically increased. Since all the nodes are only directly connected to its adjacent neighbors, the traverse path between two geographically separated nodes will experiences a lot of hops. As a result, the communication latency between non-adjacent nodes can become very long. Therefore, the practically achievable bandwidth can still be very small between the far-away source-destination pairs. As a result, the HPC or datacenter engineers have to heavily consider the computation locality while programming their parallel computation tasks.

The major problems we are facing in current direct-connect DCN is that:
1) The high bandwidth and low latency connections are only available locally.
2) The data center nodes are only directly connected to its neighboring nodes, e.g. to 6 nodes in a 3D Torus topology, and the connections between the far-away source-destination pairs have to go through multiple hops.
3) The store-and-forward nature of the electrical switching modules in the NICs of the datacenter nodes will add up the end-to-end latencies of the traversing packets.

In direct-connect datacenter or HPC networks, the benefits and drawbacks all come from the multi-path and multi-hop routing. The benefits, as mentioned above, come from the rich routing paths available in the architecture, which enables valiant traffic engineering and load balancing. Therefore, one set of approaches that trying to solve the problem described in A1 is by taking advantage of the multiple routing path. For example, the CamCube [2] approach explores the possibility of allowing applications to implement their own routing protocol in order to achieve specific application-level characteristics, such as trading off higher-latency for better path convergence.

Helios [5] and c-Through [6] are the two major solutions targeting on solving a similar problem as mentioned in A1, but apply to different network architectures. Both Helios and c-Through propose to use a hybrid packet/circuit switched (i.e. hybrid electrical/optical) network to combine the benefits of both technologies in a tree-based datacenter network architecture. Their target when introducing optical cut-through capabilities in the tree-based electrical datacenter network is to resolve the high-latency/low-bandwidth issues in the network. The problem of high-latency/low-bandwidth in the direct-connect network is more severe than in the tree-based network. Moreover, both Helios and c-Through use a large-scale/high-degree optical switch to interconnect the whole DCN, which imposes another limit to the scalability of the DCN. As the data center grows larger and larger, the required port count of the optical switch grows at the same pace. Meanwhile, the centralized switching architecture is vulnerable to failures, i.e. if this single optical switch fails, the whole optical embodiment of the DCN will fail.

Accordingly, there is a need for hybrid electrical-optical switching capabilities in direct-connect HPC/datacenter networks that overcomes disadvantages of the prior art.

### BRIEF SUMMARY OF THE INVENTION

The present invention is directed to optical network controller that includes controlling hybrid electrical-optical switching capabilities in a direct connect electrical network, the controlling includes employing an optical network of optical switches in parallel with electrical switches of the electrical network for providing a capability of optical bypassing of the electrical switches, configuring a topology of the optical network and a topology of the electrical network the same while a number of optical switches in the optical network can be equal to or less than the number of electrical switches, and mixing use of optical switches and electrical switches for routing information within the network to enable increased bandwidth throughput between interconnected nodes of the electrical switches and optical switches and reducing communication latency within the network.

In a similar aspect of the invention, there is provided a method for providing hybrid electrical-optical switching capabilities in a direct connect electrical network, the providing includes employing an optical network of optical switches in parallel with electrical switches of the electrical network for providing a capability of optical bypassing of the electrical switches, configuring a topology of the optical network and a topology of the electrical network the same while a number of optical switches in the optical network can be equal to or less than the number of electrical switches, and mixing use of optical switches and electrical switches for routing information within the network to enable increased bandwidth throughput between interconnected nodes of the electrical switches and optical switches and reducing communication latency within the network.

In yet another similar aspect of the invention, there is provided an optical network including an optical network of optical switches in parallel with electrical switches of an electrical network for providing a capability of optical bypassing of the electrical switches in the network, a topology of the optical network and a topology of the electrical network being configured to be similar while a number of optical switches in the optical network capable of being equal to or less than the number of electrical switches, and a routing configuration for mixing use of optical switches and electrical switches for directing information within the network for enabling increased bandwidth throughput between interconnected nodes of the electrical switches and optical switches and reducing communication latency within the network.

These and other advantages of the invention will be apparent to those of ordinary skill in the art by reference to the following detailed description and the accompanying drawings.

### BRIEF DESCRIPTION OF THE DRAWINGS

FIG. 1 shows examples of a current data center network known as a Fat Tree architecture.

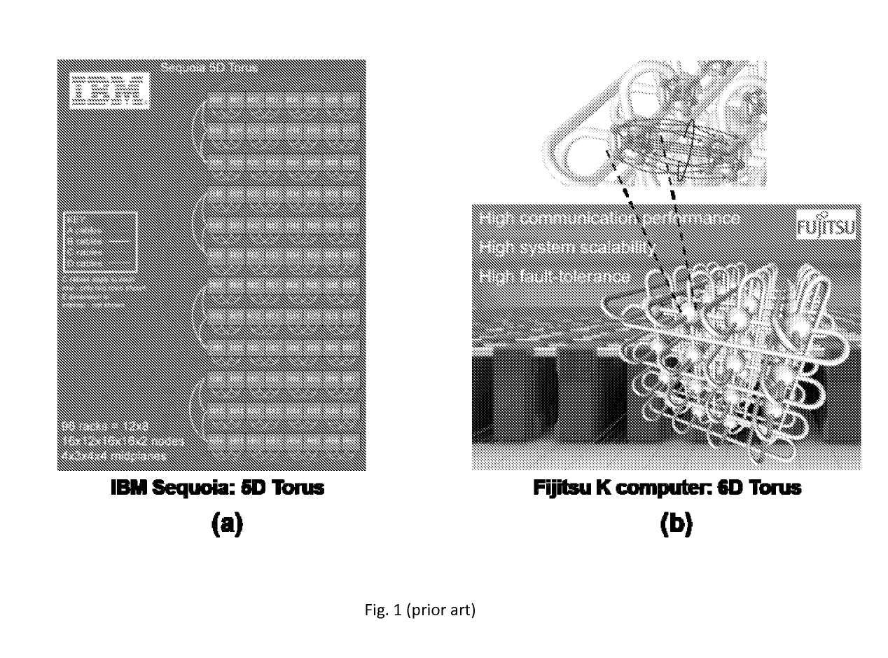

FIG. 2 shows an exemplary hybrid 2D-Torus direct-connect network with sparse optical switches in accordance with the invention.

FIG. 3 shows an exemplary hybrid 2D-Torus direct-connect network with dense optical switches in accordance with the invention.

FIG. 4 shows an exemplary hybrid 3D-Torus direct connect network with sparse optical switches in accordance with the invention.

FIG. 5 is a diagram of an exemplary computer or controller for implementing processing in the invention.

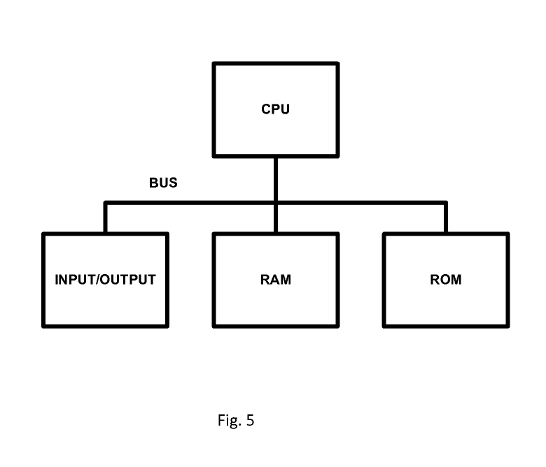

### DETAILED DESCRIPTION

The present invention provides a solution for introducing hybrid electrical-optical switching capabilities in direct-connect HPC/datacenter networks. The optical switching parts augment the electrical switching capabilities and extend the reach of the direct connections. Given this new optically augmented direct-connect HPC/DCN, an appropriate design can enable every datacenter nodes to be directly connected to any other datacenter node through an all-optical bypassing path. Therefore, the number of electrical hops between two far-away nodes can be dramatically reduced and datacenter wide high-bandwidth, low latency communications can be achieved.

The present invention proposes a hybrid optical/electrical network architecture for the direct-connect datacenters and HPC systems. It utilizes small scale optical switches in parallel with the electrical switching modules (e.g. the multi-port NIC) in the direct-connect electrical network (e.g 3D Torus) in order to provide optical bypassing capabilities. The optical network keeps the same topology as the electrical packet switching network, while the number of optical nodes can be equal or less than the electrical switching modules.

In one example of the invention, the number of optical switching nodes is less than the number of electrical switching modules. The number of optical switching nodes can be decided according to the actual requirements and the cost-performance trade off in each specific datacenters. For example, if the optical switching modules are equipped every 8 nodes in a 16×16×16 3D Torus topology (4096 servers), we only need the total number of 8 optical switches, and the maximum electrical hop count of the network can be reduced from 24 to 12.

In another example of the invention, the number of optical switching nodes is equal to the number of electrical switching modules. In other words, each electrical switching module is equipped with an optical switching module, and the routing algorithm of the network can choose to route the packets either through the electrical hop-by-hop network or the optical bypassing network. The insertion loss of the optical switching modules will limit the reach of an optical lightpath. Such problems can be mitigated by introducing optical amplification equipment to the network.

In direct-connect datacenter or HPC networks, each computing node is directly connected to its neighboring nodes without any intermediate switches, therefore the bandwidth between these directly-connected nodes can be very high and the communication latency can be extremely low. However, when the computing nodes are exchanging information with nodes other than their direct neighbors, the packets have to go through multiple hops and therefore experience multiple store-and-forward delay at each switching modules (usually the multi-port NIC at each computing node). This is the inherent nature of a direct-connect network, since the responsibility of switching and routing tasks in the whole system is broken down into small switching and routing engines at all the nodes. The drawback of such networks is also this multi-hopping nature. One of the consequences is that the latency between two far-away located nodes are high, and therefore the programmers have to consider the computing locality to restrict most of the traffic to the neighboring nodes only.

Optical communication technologies have the inherent nature of bringing two far-away nodes close to each other. The capability of optical bypassing will eliminate the store-and-forward latency and directly connect two nodes together once a lightpath is established. The present invention aims at bringing the optical bypassing capabilities to the direct-connect datacenter networks and HPC systems. It makes mixed use of both electrical packet switches and optical circuit switches. In a typical direct-connect datacenter, servers are organized in racks. The number of servers that can be mounted in a rack is determined by the size of the rack and the power management plan. There is no top-of-rack (TOR) switches in the direct-connect datacenter, as oppose to the Tree-based datacenters. Taking an example of a 3D Torus (one instance of a direct-connect network) topology, each server is equipped with a 6-port NIC, and each port of the NIC is directly connected to the server to its up and down, east and west, as well as north and south. The NIC itself has switching (w/ or w/o routing) functionalities. Therefore if the packet received by one port of the NIC is not targeted to its host, it will be forwarded to one of the output port according to a local forwarding table.

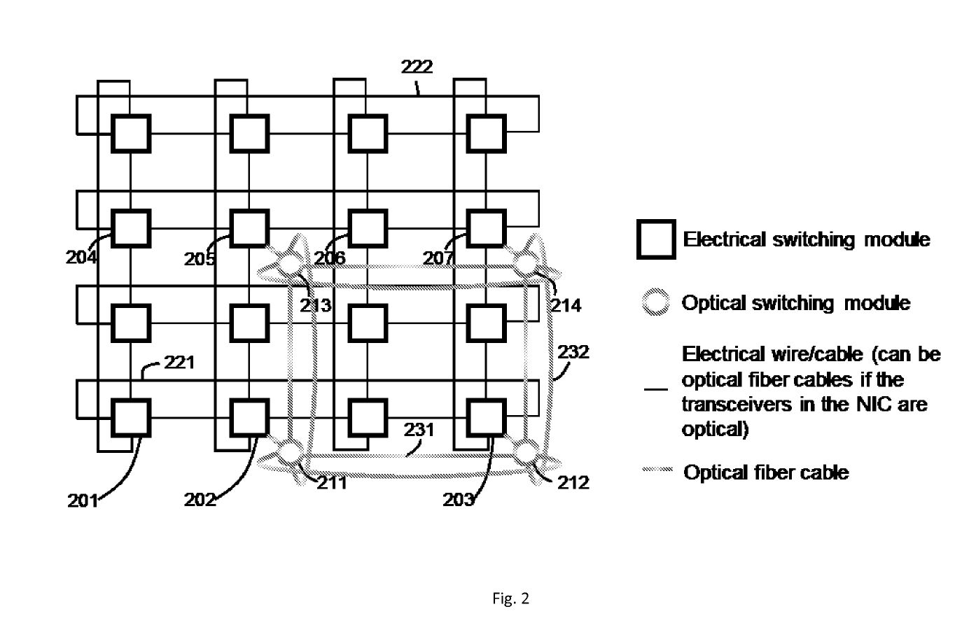

The present invention aims at bringing the optical bypassing functionality into direct-connect networks, without being restricted to a certain instance of such networks. For the simplicity of explanation, the present invention takes the example of the 2D Torus and 3D Torus network, in which each switching module (either the NIC of servers or the optical switches) is represented by a vertex of the graph, and each link (either electrical wire/cable or optical fiber cable) is represented by an edge of the graph. As shown in FIG. 2, one example of the present invention is to add the sparse optical switching modules to the electrical direct-connect network. For example, in the 4×4 2D Torus network, four electrical switching modules (202, 203, 205, 207) out of the 16 can be connected to a 5-port optical switching node (211, 212, 213, 214). The NIC of 202, 203, 205 and 207 should have five ports and at least one of the ports should be equipped with optical transceivers, which can be optical pluggable modules or integrated lasers and modulators on the NIC. The optical transceiver is then connected with one port of the 5-port optical switch. The rest four ports of the NIC can be directly connected to its neighboring NIC to the east, west, north and south, either using optical fibers if they are also equipped with optical transceivers, or using electrical wires/cables (221, 222, e.g. CAT5/6 cables) if they are not.

By attaching the optical switches to the electrical switches, the out-going packets have the option of bypassing up to 3 nodes. For instance, if the packets from node 205 would like to go to node 203, the all-electrical routing path has to go through 4 hops no matter which route it takes. With the optical switches, after the lightpath of 213-214-212 or 213-211-212 has been established, the packets from 205 can directly reach 203.

The introduction of 4 optical switches in the 16-node 2D Torus network can reduce the maximum hop count from 4 to 3. Although the savings of hop counts does not seem to be significant in this particular example, the savings can be huge in a large scale Torus network where one optical “hop” can bypass a large number of electrical hops.

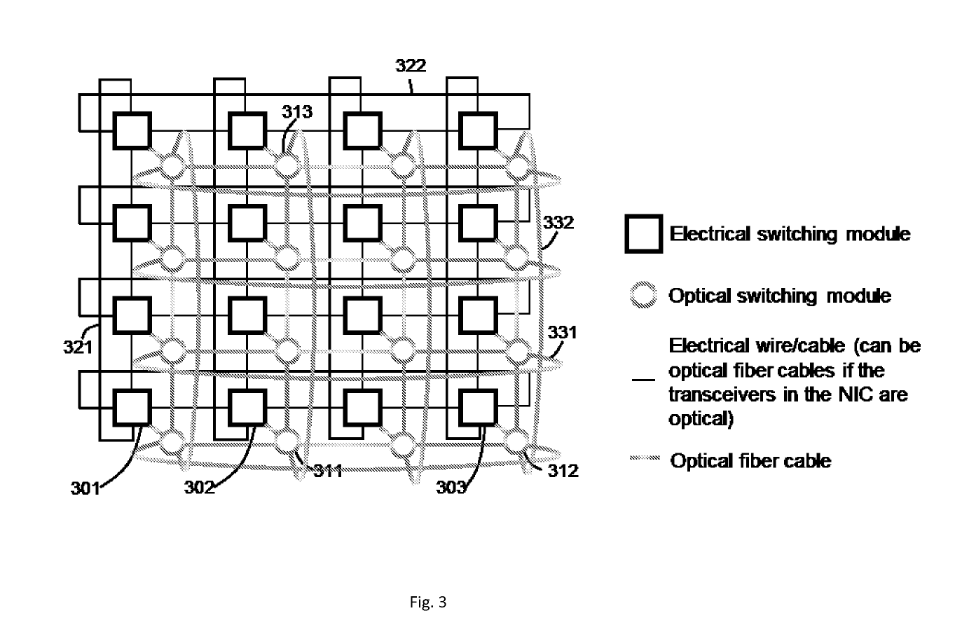

One embodiment of the present invention is shown in FIG. 3, in which case the optical switching node is connected to each electrical switching element. The hybrid network in FIG. 3 enables any-to-any one hop connection using optical bypassing. The performance can be greatly boosted using the dense hybrid optical/electrical direct-connect networks as shown in FIG. 3, but the boost come with costs. One of the costs, other than the increased CAPEX (capital expenditure) on the equipment, comes from the fact that more optical transceivers results in higher probability of optical path contention. Since optical switches are relatively slow in speed, circuit switching is still dominant switching method, which means the statistical multiplexing cannot be used to solve the traffic contention. Wavelength division multiplexing (WDM) is one way to solve the contention problem, however the use of WDM transceivers (and especially tunable ones) would result in significantly higher cost and system complexity (since WDM (de)multiplexing modules should be included). Besides, each optical switching module will introduce insertion loss. As the number of optical switching node grows larger, optical amplifiers have to be introduced to compensate the power loss, which is another source of cost increase.

Therefore, the practical number of optical switching node that should be used in the hybrid direct-connect network depends on the actual design of a specific datacenter. The present invention does not specify the number of optical nodes in the datacenter networks or HPC systems, but rather suggests the hybrid electrical/optical network architecture.

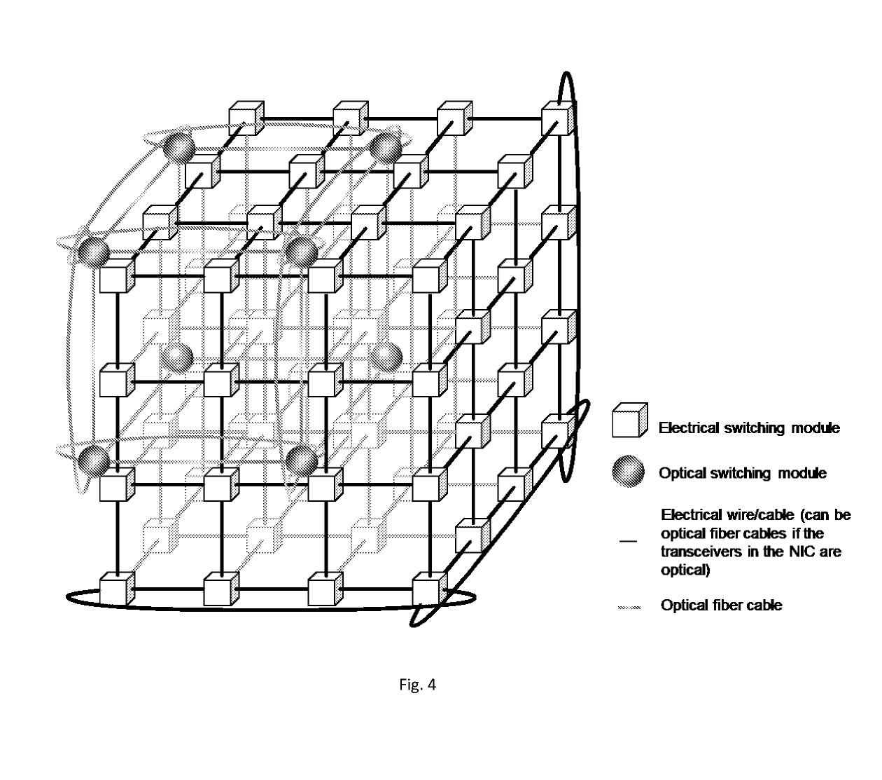

FIG. 4 gives an example of the present invention with sparse optical switches in a 4×4×4 3D Torus network topology. The drawings in FIG. 4 omitted most of the electrical loopback links (the link which connect the first and last nodes in each row and column) for simplicity purpose. By adding 8 optical switching nodes in the 64-node 3D Torus network, the maximum hop count can be reduced from 6 to 4.

There are different optical switching technologies which can be used to build the optical switching modules in the present invention. A commonly used, low cost technology is MEMS based optical switch. Other technologies such as liquid crystal/SOA (semiconductor optical amplifier) based optical gate matrix, and tunable laser plus cyclic arrayed waveguide grating (CAWG), etc. can all be the candidates. The present invention does not restrict the technologies used for the optical switching modules.

The present invention does not specify the technologies in the network control plane. Software defined network (SDN) controllers or any other type of network operating systems can be used in the present invention to provide the routing, scheduling and other control functionalities in the network.

The invention may be implemented in optical components, controller/computer hardware, firmware or software, or a combination of the three. Preferably, data processing aspects of the invention is implemented in a computer program executed on a programmable computer or a controller having a processor, a data storage system, volatile and non-volatile memory and/or storage elements, at least one input device and at least one output device. More details are discussed in U.S. Pat. No. 8,380,557, the content of which is incorporated by reference.

By way of example, a block diagram of a computer or controller to support the invention is discussed next in FIG. 4. The computer or controller preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

From the foregoing, it can be appreciated that the present invention offers significant advantages:
1) The proposed hybrid optical/electrical switching architecture solves the critical long-latency problem in direct-connect datacenter networks and HPC networks.
2) The present invention offers connectivity between servers at both the packet and the circuit granularity.
3) The present invention allows the traffic to be aggregated/de-aggregated and converted between the optical and electrical domain at each optical switching spot.
4) The present invention improves power efficiency in data center networks, and therefore saves the operational cost.
5) The present invention offers resiliency in optical interconnectivity.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. An optical network controller comprising:
controlling hybrid electrical-optical switching capabilities in a direct connect electrical network, the controlling comprising:
employing an optical network of optical switches in parallel with electrical switches of the electrical network for providing a capability of optical bypassing of the electrical switches;
configuring a topology of the optical network and a topology of the electrical network the same while a number of optical switches in the optical network can be equal to or less than the number of electrical switches; and
mixing use of optical switches and electrical switches for routing information within the network to enable increased bandwidth throughput between interconnected nodes of the electrical switches and optical switches and reducing communication latency within the network.

2. The optical network controller of claim 1, wherein the optical network comprises employing the optical switches to augment the electrical switches and extend the reach of direct connections in the network and enable every node in the network to be directly connected to any other node in the network through an all-optical bypassing path thereby reducing electrical hops between two far away nodes in the network and increasing bandwidth in the network.

3. The optical network controller of claim 1, wherein when the number of optical switches is equal to the number of electrical switches each electrical switch is equipped with an optical switch and a routing sequence of the network can choose to route packets in the network either through the electrical network hop-by-hop or bypass any of the electrical switches by routing the packets through any parallel switches of the optical network.

4. The optical network controller of claim 1, wherein when the number of optical switches is less than the number of electrical switches the number of optical switches employed is responsive to requirements and cost-performance trade-off for the network.

5. A method comprising:
providing hybrid electrical-optical switching capabilities in a direct connect electrical network, the providing comprising:
employing an optical network of optical switches in parallel with electrical switches of the electrical network for providing a capability of optical bypassing of the electrical switches; and
configuring a topology of the optical network and a topology of the electrical network the same while a number of optical switches in the optical network can be equal to or less than the number of electrical switches; and
mixing use of optical switches and electrical switches for routing information within the network to enable increased bandwidth throughput between interconnected nodes of the electrical switches and optical switches and reducing communication latency within the network.

6. The method of claim 5, wherein the optical network comprises employing the optical switches to augment the electrical switches and extend the reach of direct connections in the network and enable every node in the network to be directly connected to any other node in the network through an all-optical bypassing path thereby reducing electrical hops between two far away nodes in the network and increasing bandwidth in the network.

7. The method of claim 5, wherein when the number of optical switches is equal to the number of electrical switches each electrical switch is equipped with an optical switch and a routing sequence of the network can choose to route packets in the network either through the electrical network hop-by-hop or bypass any of the electrical switches by routing the packets through any parallel switches of the optical network.

8. The method of claim 1, wherein when the number of optical switches is less than the number of electrical switches the number of optical switches employed is responsive to requirements and cost-performance trade-off for the network.

9. An optical network comprising:
an optical network of optical switches in parallel with electrical switches of an electrical network for providing a capability of optical bypassing of the electrical switches in the network,
a topology of the optical network and a topology of the electrical network being configured to be similar while a number of optical switches in the optical network capable of being equal to or less than the number of electrical switches; and
a routing configuration for mixing use of optical switches and electrical switches for directing information within the network for enabling increased bandwidth throughput between interconnected nodes of the electrical switches and optical switches and reducing communication latency within the network.

10. The optical network of claim 8, wherein the optical network comprises employing the optical switches to augment the electrical switches and extend the reach of direct connections in the network and enable every node in the network to be directly connected to any other node in the network through an all-optical bypassing path thereby reducing electrical hops between two far away nodes in the network and increasing bandwidth in the network.

11. The optical network of claim 8, wherein when the number of optical switches is equal to the number of electrical switches each electrical switch is equipped with an optical switch and a routing sequence of the network can choose to route packets in the network either through the electrical network hop-by-hop or bypass any of the electrical switches by routing the packets through any parallel switches of the optical network.

12. The optical network of claim 8, wherein when the number of optical switches is less than the number of electrical switches the number of optical switches employed is responsive to requirements and cost-performance trade-off for the network.
